(19) United States
(12) Patent Application Publication
(10) Pub. No.: US 2024/0164975 A1
(43) Pub. Date: May 23, 2024

(54) CONVENIENTLY-STORED UNDERARM CRUTCH

(71) Applicant: Zhongshan Jiale Rehabilitation Medical Equipment Co., Ltd., Zhongshan (CN)

(72) Inventor: Panpan ZHANG, Suizhou (CN)

(21) Appl. No.: 18/119,247

(22) Filed: Mar. 8, 2023

(30) Foreign Application Priority Data
Nov. 23, 2022 (CN) 2022231111212

(51) Int. Cl. A61H 3/02

(52) U.S. Cl. CPC A61H 3/0277

(57) ABSTRACT

A conveniently-stored underarm crutch is provided. The underarm crutch includes an underarm support, two upper limb tubes parallel to each other, a handle, a connecting base and a foot tube. The underarm support is disposed above upper ends of the two upper limb tubes, the handle is disposed between the two upper limb tubes, the connecting base is provided with two inserting holes, the two upper limb tubes are respectively inserted into the two inserting holes, the connecting base is provided with elastic pieces configured to lock the two upper limb tubes in the inserting holes, an end of each of the elastic pieces is connected to a corresponding one of the two upper limb tubes, another end of each of the elastic pieces is connected to the connecting base, and the foot tube is connected to the connecting base.

### TECHNICAL FIELD

The disclosure relates to the technical field of crutches, and particularly to an underarm crutch which is convenient to be stored.

### BACKGROUND

Most of underarm crutches on the market cannot be folded. A length of the underarm crutch used by adults is about 1.2 meters, which will cause inconvenience to users when packaging, transporting and storing the underarm crutch due to the length of the underarm crutch.

The disclosure provides an underarm crutch to overcome the above problem.

### SUMMARY

For the technical problem that the length of the underarm crutch will bring inconvenience to users when packaging, transporting and storing the underarm crutch, the disclosure provides technical solutions as follows: a conveniently-stored underarm crutch, including: an underarm support, two upper limb tubes parallel to each other, a handle, a connecting base and a foot tube; where the underarm support is disposed above upper ends of the two upper limb tubes, the handle is disposed between the two upper limb tubes, the connecting base is provided with two inserting holes, the two upper limb tubes are respectively inserted into the two inserting holes, the connecting base is provided with elastic pieces configured to lock the two upper limb tubes in the inserting holes, an end of each of the elastic pieces is connected to a corresponding one of the two upper limb tubes, another end of each of the elastic pieces is connected to the connecting base, and the foot tube is connected to the connecting base.

In an embodiment of the conveniently-stored underarm crutch, each of the elastic pieces includes a rubber band, an end of the rubber band is connected in the upper limb tube through a locating pin, and another end of the rubber band is snapped into the connecting base.

In an embodiment of the conveniently-stored underarm crutch, two upper sliding rods are disposed under a bottom of the underarm support, the two upper sliding rods are respectively slidably connected in the two upper limb tubes, the handle is provided with two connecting holes, the two upper limb tubes are respectively slidably connected in the two connecting holes, and a locking mechanism configured to lock the handle between the two upper limb tubes is disposed on the handle.

In an embodiment of the conveniently-stored underarm crutch, each of the two upper sliding rods is provided with multiple first positioning holes, each of the two upper limb tubes is provided with multiple second positioning holes which are respectively communicated with the multiple first positioning holes of the upper sliding rod, and the locking mechanism includes sliding blocks, inserting pins and elastic members; the sliding blocks are slidably connected to the handle, the inserting pins are connected to the sliding blocks respectively, each of the inserting pins is configured to insert into one of the first positioning holes and the second positioning hole communicated with the one of the first positioning holes, the elastic members are disposed in the handle, and each of the elastic members is configured to drive a corresponding one of the sliding blocks to move, thereby to make the inserting pin be inserted into the first positioning hole and the second positioning hole.

In an embodiment of the conveniently-stored underarm crutch, an upper part of the underarm support is provided with an airbag, and the airbag is connected to an inflation device configured to inflate the airbag.

In an embodiment of the conveniently-stored underarm crutch, a lower sliding rod is slidably connected in the foot tube, the foot tube is provided with multiple third positioning holes, and the lower sliding rod is provided with multiple resilient protrusions configured to be snapped into the multiple third positioning holes, respectively.

In an embodiment of the conveniently-stored underarm crutch, a vibration damping rod is slidably connected in the lower sliding rod, and a vibration damping mechanism is disposed between the lower sliding rod and the vibration damping rod; the vibration damping mechanism includes a first positioning ring, a second positioning ring, a guide rod, a spring, and a locking bolt; the first positioning ring is fixedly connected in the lower sliding rod, the second positioning ring is fixedly connected in the vibration damping rod, an upper part of the guide rod is slidably connected in the first positioning ring, the locking bolt locks a lower part of the guide rod in the second positioning ring, the spring is sleeved on the guide rod, and the spring is disposed between the first positioning ring and the second positioning ring.

In an embodiment of the conveniently-stored underarm crutch, a lower end of the vibration damping rod is provided with an antiskid piece.

In an embodiment of the conveniently-stored underarm crutch, the connecting base is provided with an avoidance hole configured to be passed by a hand.

The beneficial effects of the disclosure are as follows:
1. The conveniently-stored underarm crutch disclosed by the disclosure provides the inserting holes on the connecting base for the upper limb tubes to be inserted in the inserting holes, and the upper limb tubes are locked in the inserting holes through the elastic pieces. When the underarm crutch is needed to be used, the two upper limb tubes are respectively inserted in the inserting holes. When the underarm crutch is needed to be stored, the two upper limb tubes are pulled out from the inserting holes, then the underarm crutch are divided into two sections, and the two sections are connected to each other through the elastic pieces and are not easy to lose any section, which is convenient for use and storage.
2. The locking mechanism can not only adjust a relative distance between the connecting base and the underarm support, but also adjust a relative distance between the handle and the underarm support.

### BRIEF DESCRIPTION OF DRAWINGS

FIG. 1 is a schematic structural view of an underarm crutch in the disclosure.

FIG. 2 is an exploded view of the underarm crutch in the disclosure.

FIG. 3 is a sectional schematic view of the underarm crutch in the disclosure.

FIG. 4 is an enlarged view of part A marked in FIG. 3.

FIG. 5 is an is an enlarged view of part B marked in FIG. 3.

### DETAILED DESCRIPTION OF EMBODIMENTS

Embodiments of the disclosure will be described in detail below with reference to the attached drawings.

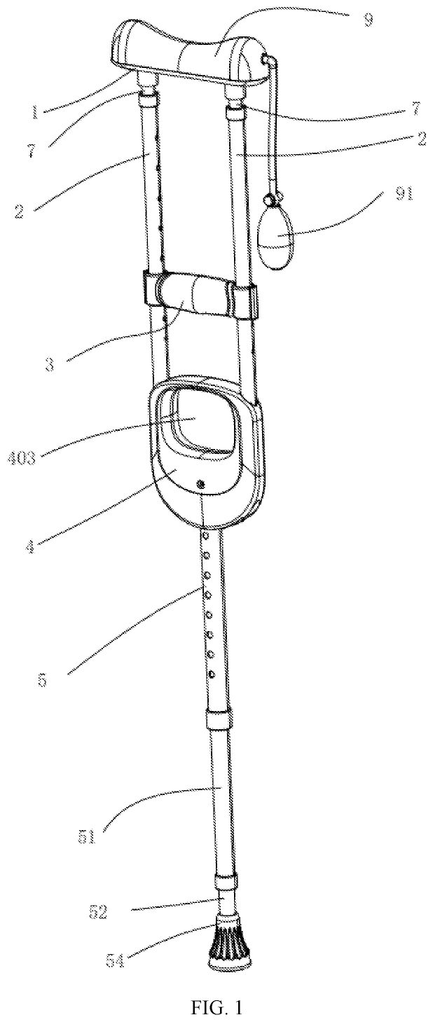

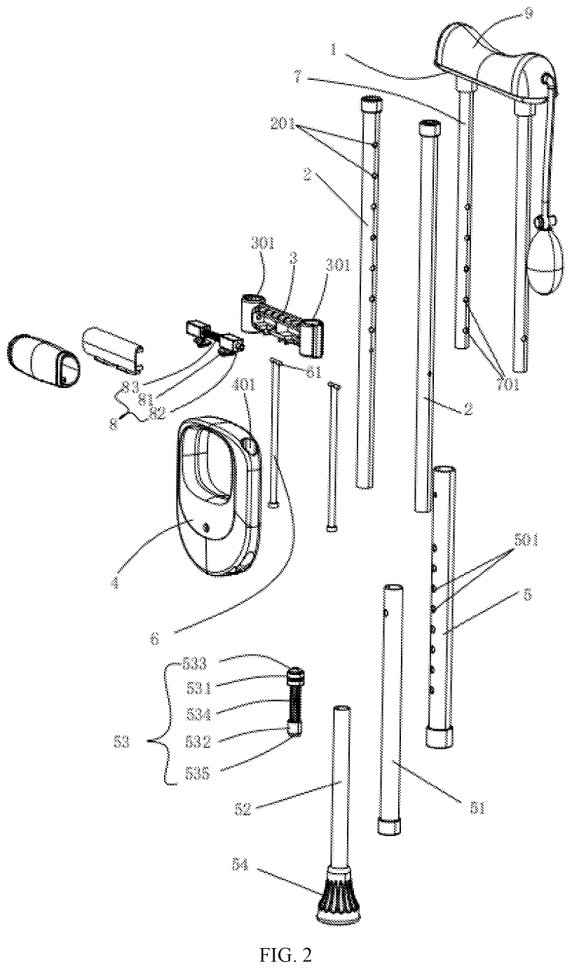

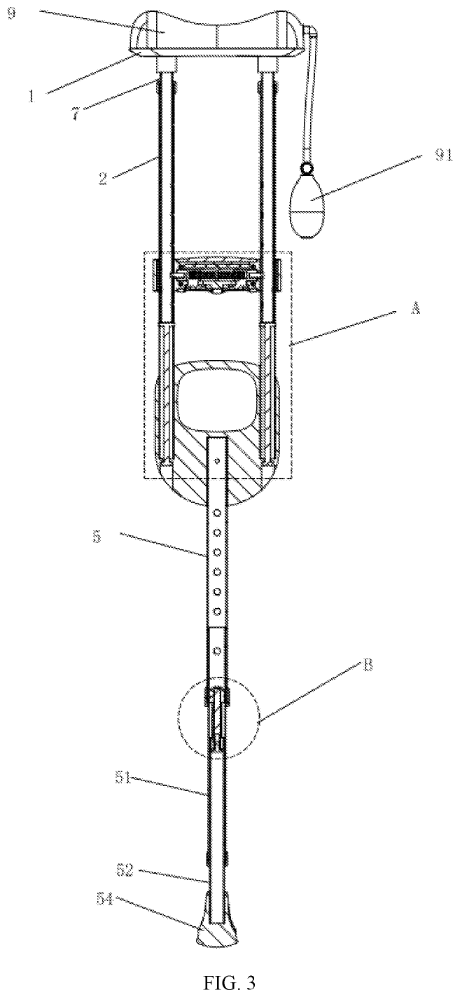

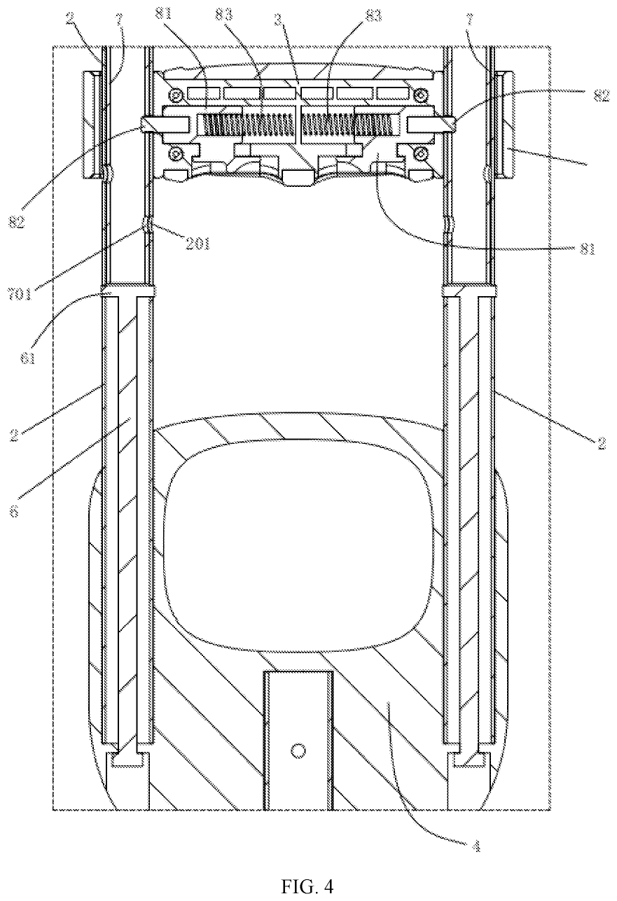

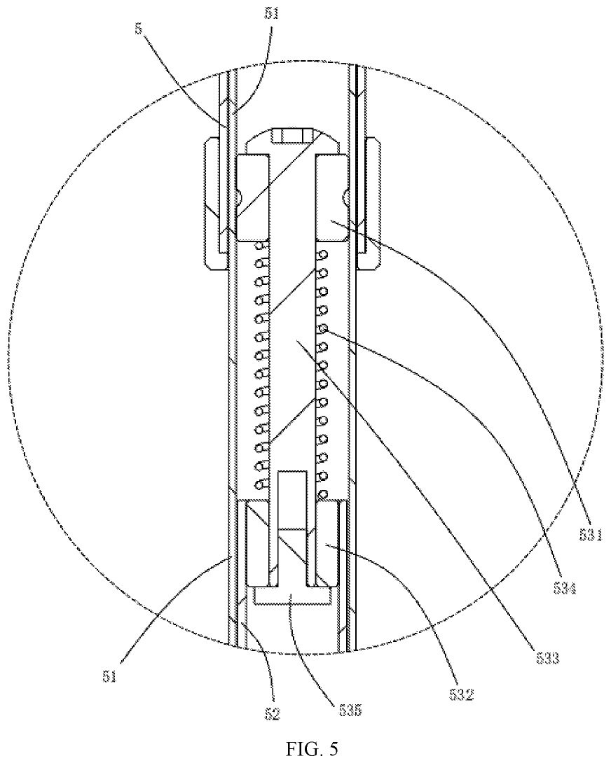

As shown in FIG. 1 to FIG. 5, a conveniently-stored underarm crutch in an embodiment includes: an underarm support 1, two upper limb tubes 2 parallel to each other, a handle 3, a connecting base 4 and a foot tube 5. The underarm support 1 is disposed above upper ends of the two upper limb tubes 2, the handle 3 is disposed between the two upper limb tubes 2, the connecting base 4 is provided with two inserting holes 401, the two upper limb tubes 2 are respectively inserted into the two inserting holes 401, the connecting base 4 is provided with elastic pieces 6 configured to lock the two upper limb tubes 2 in the inserting holes 401, an end of each of the elastic pieces 6 is connected to a corresponding one of the two upper limb tubes 2, another end of each of the elastic pieces 6 is connected to the connecting base 4, and the foot tube 5 is connected to the connecting base
4. The conveniently-stored underarm crutch of the disclosure provides the inserting holes 401 on the connecting base 4 for the upper limb tubes 2 to be inserted in the inserting holes 401, and the underarm crutch locks the upper limb tubes 2 in the inserting holes 401 through the elastic pieces 6. When the underarm crutch is needed to be used, the two upper limb tubes 2 are respectively inserted in the inserting holes 401. When the underarm crutch is needed to be stored, the two upper limb tubes 2 are pulled out from the inserting holes 401, then the underarm crutch are divided into two sections, and the two sections are connected to each other through the elastic pieces 6 and are not easy to lose any section, which is convenient for use and storage.

In the embodiment, each of the elastic pieces 6 includes a rubber band, an end of the rubber band is connected in the corresponding upper limb tube 2 through a locating pin 61, and another end of the rubber band is snapped into the connecting base 4.

In order to adjust a relative distance between the underarm support 1 and the connecting base 4, two upper sliding rods 7 are disposed under a bottom of the underarm support 1, the two upper sliding rods 7 are respectively slidably connected in the two upper limb tubes 2, the handle 3 is provided with two connecting holes 301, the two upper limb tubes 2 are respectively slidably connected in the two connecting holes 301, and a locking mechanism 8 configured to lock the handle 3 between the two upper limb tubes 2 is disposed on the handle 3.

In the embodiment, each of the two upper sliding rods 7 is provided with multiple first positioning holes 701, each of the two upper limb tubes 2 is provided with multiple second positioning holes (201) which are respectively communicated with the multiple first positioning holes (701) of the upper sliding rod 7, and the locking mechanism 8 includes sliding blocks 81, inserting pins 82, and elastic members 83; the sliding blocks 81 are slidably connected to the handle 3, the inserting pins 82 are connected to the sliding blocks 81 respectively, each of the inserting pins 82 is configured to insert into one of the first positioning holes 701 and the second positioning hole 201 communicated with the one of the first positioning holes 701, the elastic members 83 are disposed in the handle 3, and each of the elastic members 83 is configured to drive a corresponding one of the sliding blocks 81 to move, thereby to make the inserting pin 82 be inserted into the first positioning hole 701 and the second positioning hole 201. By this design, the underarm crutch can not only adjust a relative distance between the connecting base 4 and the underarm support 1, but also adjust a relative distance between the handle 3 and the underarm support 1.

In order to improve the comfort when using the underarm crutch, an upper part of the underarm support 1 is provided with an airbag 9, and the airbag 9 is connected to an inflation device 91 configured to inflate the airbag 9. A size of the airbag 9 can be changed according to the needs of a user, and thus the underarm crutch can be applied to people of different physiques and is more comfortable to be used.

In the embodiment, in order to adjust a relative height between the connecting base 4 and the ground, a lower sliding rod 51 is slidably connected in the foot tube 5, the foot tube 5 is provided with multiple third positioning holes 501, and the lower sliding rod 51 is provided with multiple resilient protrusions (not shown in the FIGs) configured to be snapped into the multiple third positioning holes 501, respectively.

In order to reduce the vibration when using the underarm crutch, a vibration damping rod 52 is slidably connected in the lower sliding rod 51, and a vibration damping mechanism 53 is disposed between the lower sliding rod 51 and the vibration damping rod 52; the vibration damping mechanism 53 includes a first positioning ring 531, a second positioning ring 532, a guide rod 533, a spring 534, and a locking bolt 535; the first positioning ring 531 is fixedly connected in the lower sliding rod 51, the second positioning ring 532 is fixedly connected in the vibration damping rod 52, an upper part of the guide rod 533 is slidably connected in the first positioning ring 531, the locking bolt 535 locks a lower part of the guide rod 533 in the second positioning ring 532, the spring 534 is sleeved on the guide rod 533, and the spring 534 is disposed between the first positioning ring 531 and the second positioning ring 532.

In order to prevent slipping, a lower end of the vibration damping rod 52 is provided with an antiskid piece 54.

In the embodiment, the connecting base 4 is provided with an avoidance hole 403 configured to be passed by a hand. When the underarm crutch needs to be stored, one hand holds the underarm support 1, and the other hand extends into the avoidance hole 403 to facilitate removing the two upper limb tubes 2 from the inserting holes 401.

The above only uses an embodiment to further explain the technical solution of the disclosure, so that readers can understand it more easily, but it does not mean that the embodiments of the disclosure are limited to this. Any technical extension or re-creation made according to the disclosure should be protected by the disclosure. The scope of protection of the disclosure is subject to the claims.

What is claimed is:

1. An underarm crutch, comprising: an underarm support (1), two upper limb tubes (2) parallel to each other, a handle (3), a connecting base (4) and a foot tube (5); wherein the underarm support (1) is disposed above upper ends of the two upper limb tubes (2), the handle (3) is disposed between the two upper limb tubes (2), the connecting base (4) is provided with two inserting holes (401), the two upper limb tubes (2) are respectively inserted into the two inserting holes (401), the connecting base (4) is provided with elastic pieces (6) configured to lock the two upper limb tubes (2) in the inserting holes (401), an end of each of the elastic pieces (6) is connected to a corresponding one of the two upper limb tubes (2), another end of each of the elastic pieces (6) is connected to the connecting base (4), and the foot tube (5) is connected to the connecting base (4).

2. The underarm crutch according to claim 1, wherein each of the elastic pieces (6) comprises a rubber band, an end of the rubber band is connected in the corresponding upper limb tube (2) through a locating pin (61), and another end of the rubber band is snapped into the connecting base (4).

3. The underarm crutch according to claim 1, wherein two upper sliding rods (7) are disposed under a bottom of the underarm support (1), the two upper sliding rods (7) are respectively slidably connected in the two upper limb tubes (2), the handle (3) is provided with two connecting holes (301), the two upper limb tubes (2) are respectively slidably connected in the two connecting holes (301), and a locking mechanism (8) configured to lock the handle (3) between the two upper limb tubes (2) is disposed on the handle (3).

4. The underarm crutch according to claim 3, wherein each of the two upper sliding rods (7) is provided with a plurality of first positioning holes (701), each of the two upper limb tubes (2) is provided with a plurality of second positioning holes (201) which are respectively communicated with the plurality of first positioning holes (701) of the upper sliding rod (7), and the locking mechanism (8) comprises sliding blocks (81), inserting pins (82), and elastic members (83); the sliding blocks (81) are slidably connected to the handle (3), the inserting pins (82) are connected to the sliding blocks (81) respectively, each of the inserting pins (82) is configured to insert into one of the first positioning holes (701) and the second positioning hole (201) communicated with the one of the first positioning holes (701), the elastic members (83) are disposed in the handle (3), and each of the elastic members (83) is configured to drive a corresponding one of the sliding blocks (81) to move, thereby to make the inserting pin (82) be inserted into the first positioning hole (701) and the second positioning hole (201).

5. The underarm crutch according to claim 1, wherein an upper part of the underarm support (1) is provided with an airbag (9), and the airbag (9) is connected to an inflation device (91) configured to inflate the airbag (9).

6. The underarm crutch according to claim 1, wherein a lower sliding rod (51) is slidably connected in the foot tube (5), the foot tube (5) is provided with a plurality of third positioning holes (501), and the lower sliding rod (51) is provided with a plurality of resilient protrusions configured to be snapped into the plurality of third positioning holes (501), respectively.

7. The underarm crutch according to claim 6, wherein a vibration damping rod (52) is slidably connected in the lower sliding rod (51), and a vibration damping mechanism (53) is disposed between the lower sliding rod (51) and the vibration damping rod (52); the vibration damping mechanism (53) comprises a first positioning ring (531), a second positioning ring (532), a guide rod (533), a spring (534), and a locking bolt (535); the first positioning ring (531) is fixedly connected in the lower sliding rod (51), the second positioning ring (532) is fixedly connected in the vibration damping rod (52), an upper part of the guide rod (533) is slidably connected in the first positioning ring (531), the locking bolt (535) locks a lower part of the guide rod (533) in the second positioning ring (532), the spring (534) is sleeved on the guide rod (533), and the spring (534) is disposed between the first positioning ring (531) and the second positioning ring (532).

8. The underarm crutch according to claim 7, wherein a lower end of the vibration damping rod (52) is provided with an antiskid piece (54).

9. The underarm crutch according to claim 1, wherein the connecting base (4) is provided with an avoidance hole (403) configured to be passed by a hand.
